(19) United States
(12) Patent Application Publication
(10) Pub. No.: US 2013/0202973 A1
(43) Pub. Date: Aug. 8, 2013

(54) IONIC LIQUIDS FOR BATTERIES

(71) Applicants: George Hamilton Lane, Tasmania (AU); Adam Samuel Best, Victoria (AU); Anand I. Bhatt, Frankston South (AU); Youssof Shekibi, Victoria (AU); Bronya R. Clare, Auckland (NZ)

(72) Inventors: George Hamilton Lane, Tasmania (AU); Adam Samuel Best, Victoria (AU); Anand I. Bhatt, Frankston South (AU); Youssof Shekibi, Victoria (AU); Bronya R. Clare, Auckland (NZ)

(73) Assignees: MONASH UNIVERSITY, Victoria (AU); COMMONWEALTH SCIENTIFIC AND INDUSTRIAL RESEARCH ORGANISATION, Campbell (AU)

(21) Appl. No.: 13/635,825

(22) PCT Filed: Mar. 18, 2011
(86) PCT No.: PCT/AU2011/000308

§ 371 Date: Apr. 2, 2013

(30) Foreign Application Priority Data
Mar. 18, 2010 (AU) 2010901143

(51) Int. Cl. H01M 10/056; H01M 10/052

(52) U.S. Cl. CPC H01M 10/056; H01M 10/052
USPC 429/341; 429/188; 429/199

(57) ABSTRACT

An organic cation for a battery, including a heteroatom-containing cyclic compound having at least (2) ring structures formed from rings that share at least one common atom, the cyclic compound having both a formal positive charge of at least +1 and a partial negative charge.

### FIELD OF THE INVENTION

The invention relates to room temperature ionic liquids suitable for use in batteries. The invention is particularly suitable for application in lithium batteries.

### BACKGROUND OF THE INVENTION

In an electrochemical cell, a species is reduced at one electrode (ie gains electrons) and then oxidised at another electrode (ie loses electrons). The species being reduced/oxidised may be present in the electrolyte solution that connects the 2 electrodes, or may be present in the electrodes themselves, or may be from an external source. In a rechargeable lithium ion battery, both the electrolyte and the electrodes are involved in the electrochemical reaction. For example, when discharging a rechargeable lithium ion battery having a carbon anode and a LiCoO₂ cathode, the Co transition metal in the cathode is reduced (Co^{4+→Co}³⁺) and Li⁺ is extracted from the anode (LiₓC₆→xLi⁺+6C+xe⁻), which is also known as dedoping or deintercalation, and inserted into vacancies in the cathode (Li₁₋ₓCoO₂+xLi⁺+xe⁻→LiCoO₂), which is also known as doping or intercalation. When charging, Co in the cathode is oxidised (Co³⁺→Co⁴⁺) and Li⁺ is extracted from the cathode (LiCoO₂→Li₁₋ₓCoO₂+xLi⁺+xe⁻) and inserted into the anode (xLi⁺+6C+xe⁻→LixC₆). A similar situation exists for other cathode materials, which generally have the form LiMₓO_{y} where M is at least one element selected from the group consisting of Co, Ni, Mn, Fe, Al, V and Ti (such as LiMnO₂, LiFePO₄ and Li₂FePO₄F).

For an electrochemical cell, the net electromotive force (EMF) is the sum of the chemical EMF (ie the reduction/oxidation reactions during discharging), and any voltage difference EMF applied across its terminals (ie during charging). The combination of the two EMFs can thus drive current in either direction (ie allowing both discharging and charging). In general, the chemical EMF is the difference between the reduction potentials of each electrode. In a lithium ion battery, the reduction potential at the anode and cathode are measured relative to a reference electrode and the reduction potential of the cell, expressed by reference to the cathode, is the difference between these 2 values. So, the reduction potential of the cell for LiCoO₂ is about 3.7 V, for LiMnO₂ is about 4.0 V, for LiFePO₄ is about 3.3 V and for Li₂FePO₄F is about 3.6 V. The EMF may also be referred to as the discharge voltage.

Aprotic electrolytes, for example those based on compounds such as ethylene carbonate or propylene carbonate and mixtures thereof, are often employed as the electrolyte. However, these compounds have low boiling and flash points, are electrochemically unstable (ie they degrade/decompose at the electrodes which inhibits current flow), and they can be toxic. In addition, these electrolytes normally require the doping with a corrosive lithium salt, such as lithium hexafluorophosphate (LiPF₆), lithium tetrafluoroborate (LiBF₄), and lithium perchlorate (LiClO₄). These lithium salt dopants are known to degrade in the presence of trace amounts of water to form hydrofluoric acid (HF) or hydrochloric acid (HCl).

Ionic liquids (ILs) have the ability to act as both solvents and electrolytes for electrochemical devices. ILs are salt compositions (ie mixtures of cations and anions) that are molten at the temperature of interest. Room temperature ionic liquids (RTILs) are thus salt compositions that are molten at room temperature. Room temperature as used herein is taken to include the range of commonly experienced ambient temperatures rather than the scientific definition. For instance, room temperature is to be taken to be the temperature range from about 0° C. to about 100° C. RTILs have been used as electrolytes in electrochemical cells (eg batteries), capacitors, photochemical cells, electroplating, electrorefining, catalysis and synthesis.

In order to better, explain the invention, the below discusses the operation within a lithium ion battery. In a lithium ion battery, Li⁺ moves from the positive electrode to the negative anode. Achieving the high EMFs (above about 3 V) however is dependent on movement of charged species between the electrodes, which in turn is dependent on the properties of the electrolyte. In particular, the properties of the electrolyte must be such that the following problems are avoided: (1) generation of a solid electrolyte interface (SEI) layer at the negative anode that is impermeable to Li⁺, and (2) inhibition of the migration of Li⁺ through the electrolyte from the positive cathode to the negative anode by clustering of negative ions around the positive Li⁺ ion.

Regarding (1), although little is known or understood about the SEI, it is thought to occur when the electrolyte is electrochemically unstable and unfavourably degrades at an electrode. Thus, the SEI forms on the electrodes of a battery via decomposition products of the electrolyte and/or additives during the initial cycling of the device. Stabilizing the SEI serves to protect the bulk electrolyte from further decomposition. By controlling the composition, thickness and uniformity of this layer several battery properties can be improved including reducing the internal resistance of the cell, which in turn reduces self-discharge, and improvements in cell cycling efficiency. Others have attempted to stabilize the SEI, for instance by addition of an appropriate lithium salt or other additives such as vinylene carbonate, however these efforts have shown limited success due to continued cycling electrochemically consuming the additive. A further issue with the addition of lithium salt is that it substantially changes some of the physical properties of the electrolyte, including increasing the viscosity and decreasing the ionic conductivity, due mainly to strong ion-ion interactions. These strong interactions, especially between Li+ and the anion(s) of the IL electrolyte, can ‘bind’ lithium into charged dusters. These clusters are negatively charged (due to the preponderance of anions) and will thus want to migrate (the Li+) in the opposite direction to which we wish them to migrate (the Li+) under both charge and discharge. This leads to low diffusivity of the Li+ and, low transport numbers (t_{Li+}), within the bulk electrolyte.

Regarding (2), migration may be inhibited when the Li⁺ is surrounded by electrolyte anions and hence acquires a net negative charge (and so does not readily migrate towards the negative anode). As used herein, the term lithium battery is intended to encompass both lithium metal and lithium ion batteries. Therefore, the invention is directed towards overcoming one or both of these existing problems of the electrolyte.

Reference to any prior art in the specification is not, and should not be taken as, an cknowledgment or any form of suggestion that this prior art forms part of the common general knowledge in Australia or any other jurisdiction or that this prior art could reasonably be expected to be ascertained, understood and regarded as relevant by a person skilled in the art.

### SUMMARY OF THE INVENTION

In one aspect of the invention there is provided an electrolyte when used in a battery, the electrolyte including a first organic cation, the first organic cation including, consisting essentially of or consisting of a heteroatom-containing cyclic compound having (i) at least 2 ring structures that share at least one common atom, the cyclic structure having and (ii) both a formal positive charge of at least +1 and a partial negative charge.

The cyclic compound may include rings joined at a single atom (termed herein spirocyclic rings), rings fused at adjacent atoms (termed herein fused rings), or bridging rings joined by non-adjacent atoms (termed herein bridgehead rings). The cyclic compound has at least 2 ring structures (termed herein bicyclic) or may have more that 2 ring structures; for instance, 3, 4 or 5 rings.

In some embodiments, the first organic cation and a first anion form a first ionic liquid. In these embodiments, the electrolyte may include, consist essentially of, or consist of the first organic cation and a first anion as an ionic liquid.

In some embodiments, the electrolyte further includes a second ionic liquid having a second organic cation and a second anion. In these embodiments, the structure of the second organic cation need not be the same as that of the first organic cation described herein, and instead may be any ionic liquid organic cation known in the art. The second organic cation may be any known in the art, for instance, imidazolium (eg 1-ethyl-3-methylimidazolium (EMI)), pyrrolidinium or morpholinium or derivatives thereof. The first and second anions may also be any known in the art, for instance, hexafluorophosphate (PF₆), tetrafluoroborate (BF₄), perchlorate (ClO₄), bis(fluorosulfonyl)imide (FSI) or bis(trifluoromethanesulfonyl)imide (TFSI) or derivatives thereof. In these embodiments, the first organic cation may be used as a dopant to the second ionic liquid, or the electrolyte may include, consist essentially of, or consist of both the first ionic liquid and the second ionic liquid. In these embodiments, the amount of the first organic cation as a percentage of the total organic cation (eg first organic cation and second organic cation) may be from about 1% to about 99%.

The battery may be an alkali-metal battery, such as a lithium battery (eg lithium metal or lithium ion), or a transition metal battery. Preferably, the battery is a lithium metal or lithium ion battery. More preferably, the battery is a lithium metal battery.

The electrolyte may further include a metal salt. Preferably, for the application of the electrolyte in a lithium battery the metal salt is a lithium salt including a Li cation.

The chemical nature of the first organic cation is such that it is at least partially attracted or weakly bound to the Li cation of the lithium battery. That is, the first organic cation is such that it coordinates or interacts with the Li cation of the lithium battery. The desirable degree of such interaction will depend on the application, but will be that which results in the requisite balance between (i) interacting sufficiently strongly to shield or destabilise the Li cation from the stronger interaction with the anion of the electrolyte (eg the first or second anion) and (ii) interacting sufficiently weakly to allow the Li cation to interact at the electrodes. Thus, when in use, the partial negative charge of the first organic cation coordinates or interacts with the Li cation.

Preferably, the formal positive charge and the partial negative charge are separated such that the first organic cation has a net dipole. For instance, the formal positive charge may be present on an opposite portion of a, ring to the partial negative charge. Or, the formal positive charge may be present on a different ring to the partial negative charge. Most preferably, the formal positive charge is present on or near the portion that is between 2 rings. That is, the formal positive charge may be the Spiro atom, or one of the joining atoms in a fused ring.

A positive functional group provides the formal positive charge by including a first element from Group 15 of the Periodic Table of the Elements. In some embodiments, the first element participates in, or forms, 4 covalent bonds in the first organic cation Such that a formal positive charge results. Preferably, the first element is N or P. A positive functional group may contain more than one first element, which may be the same or different.

A negative functional group provides the partial negative charge by including a second element. Preferably, the second element participates in, or forms, covalent bonding such that a partial negative charge results. That is, the second element participates in; Or forms, covalent bonding such that a lone electron pair results. For instance, the second element may be the relatively electronegative elements O, S, N or F. A negative functional group may contain more than one second element, which may be the same or different.

In another aspect of the invention there is provided a battery including
at least one anode and at least one cathode; and
an electrolyte for fluid communication between the anode and cathode;
   the electrolyte including a first organic cation, the first organic cation including, consisting essentially of or consisting of a heteroatom-containing cyclic compound having at least 2 ring structures that share at least one common atom, the cyclic structure having a formal positive charge of at least +1 and a partial negative charge.

In another aspect of the invention there is provided a first organic cation including, consisting essentially of or consisting of a heteroatom-containing cyclic compound having at least 2 ring structures that share at least one common atom, the cyclic structure having a formal positive charge of at least +1 and a partial negative charge.

In preferred embodiments of this aspect, the first organic cation is as according to the above description.

In another aspect of the invention there is provided an ionic liquid including an organic dation including, consisting essentially of or consisting of a heteroatom-containing cyclic compound having at least 2 ring structures that share at least one common atom, the cyclic structure having a formal positive charge of at least +1 and a partial negative charge.

In preferred embodiments of this aspect, the first organic cation is as according to the above description.

In another aspect of the invention there is provided an ionic liquid including, consisting essentially of or consisting of a heteroatom-containing cyclic compound having at least 2 ring structures that share at least one common atom, the cyclic structure having a formal positive charge of at least +1 and a partial negative charge wherein the ionic liquid is such that use of the ionic liquid in the battery results in the formation of an appropriate SEI.

In preferred embodiments of this aspect, the first organic cation is as according to the above description.

The organic cation can be used as electrolyte in a battery or as an additive to an ionic liquid or carbonate based solvent electrolytes. If the organic cation is used as an additive it can be in the, concentration of 0.1 to 1.5 mol/kg with the preferred concentration being 0.25 mol/kg.

The ionic liquid can be made using the organic cation or can be any previously described ionic liquid for example those based on pyrrolidinium or imidazolium cations with TFSA, FSA, DCA, BF4 or PF₆ anions

The concentration of lithium ions in the electrolyte can be in the range of 0.1 to 1.5 mol/kg with the preferred concentration being 0.5 mol/kg.

The battery separator can be any commercially available separator.

### BRIEF DESCRIPTION OF THE FIGURES

FIG. 1: The Spiro-based compound whose electrochemistry is described in FIGS. 2, 3 and 4. A is the ionic liquid cation of the invention. B is an ionic liquid anion.

FIG. 2: shows an energy storage device in accordance with one embodiment of the present invention

FIG. 3: Electrochemical window of the SMK TFSA ionic liquid without lithium salt. The oxidation peaks at −1 and 0 volts are a result of the oxidation of products formed during the reductive decomposition seen negatively beyond −2 V. They do not relate to the neat ionic liquid. Platinum has been used as both the counter and working electrodes and Ag|Ag⁺ reference electrode described by Snook et al. Electrochem Commun 2006, scan rate: 50 mV.s⁻¹, scanning reductively first.

FIG. 4: Lithium cycling in the SMK TFSA 0.4 mol/kg LiTFSA. Note the lack of breakdown current until −6 V on the first scan, and the stabilisation of the current behaviour after the 2nd scan. Pt counter and working electrodes and Ag|Ag⁺ reference electrode, scan rate: 50 mV.s⁻¹, scanning reductively first.

FIG. 5: Lithium cycling of a lithium: lithium symmetrical cell containing SMK TFSA 0.4 mol/kg LiTFSA at a current density of 0.1 mA.cm⁻² and 85° C.

FIG. 6: Lithium cycling in the electrolyte 1.0 mol/kg SMK TFSA 0.5 mol/kg Li TFSA in 1-methyl-propyl-pyrrolidinium (C₃mpyr) TFSA. Currents are small but there is little decay. Pt counter and working electrodes and Ag|Ag⁺ reference electrode, scan rate: 50 mV.s⁻¹, scanning reductively first.

FIG. 7: A lithium metal battery comprising LiFePO₄ cathode (2.2 mg.cm⁻² loading), Separion separator and an electrolyte consisting of C₃mpyr TFSA with 0.25 mol/kg SMK TFSA and 0.5 mol.kg⁻¹ LiTFSA as the electrolyte. The cell was charged at 0.05 mA.cm⁻² (C/7.5) and discharged at 0.1 mA.cm⁻² (C/3.75) at 50° C.

FIG. 8: A lithium metal battery comprising a LiFePO₄ cathode (1.5 mg.cm⁻² loading), separion separator and an electrolyte consisting of C₃mpyr TFSA with 0.25 mol/kg SMK TFSA and 0.5 mol/kg LiTFSA. The cell was charged at a rate of C/10 and discharged at a rate of C/10 at 80° C.

FIG. 9: A lithium metal battery comprising a LiFePO₄ cathode (1.5 mg.cm⁻² loading), Separion separator and an electrolyte consisting of C₃mpyr TFSA with 0.25 mol/kg SMK TFSA and 0.5 mol/kg LiTFSA. The cell was charged at a rate of C/10 and discharged at a rate of C/10 at 115° C.

FIG. 10: Lithium metal batteries comprising a LiFePO₄ cathode (1.5 mg.cm⁻² loading), an electrolyte consisting of C₃mpyr TFSA with 0.25 mol/kg SMK TFSA and 0.5 mol/kg LiTFSA. The cells were charged at a rate of C/10 and discharged at a rate of C/10 at 80° C. The first cell uses a Separion separator (open circles), the second cell uses a PVdF separator (filled triangles) and the third cell uses a poly(acrylonitrile) (PAN) separator (crosses)

FIG. 11: A lithium metal battery comprising a LiFePO₄ cathode (1.5 mg.cm⁻² loading), PVdF separator and an electrolyte consisting of C₃mpyr TFSA with 0.25 mol/kg SMK TFSA and 0.5 mol/kg LiTFSA. The cell was charged at a rate of C/10 and discharged at a rate of C/10 at 120° C.

### DETAILED DESCRIPTION OF THE EMBODIMENTS

the first organic cation of the present invention has the general structure given in Formula 1:

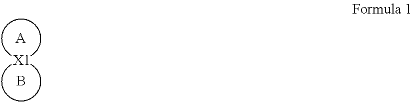

Typically, rings A and B are 5- or 6-membered rings. However, smaller and larger rings may be suitable for application in a lithium battery as could be determined by the skilled person.

Rings A and/or B include
a positive functional group including an atom (the ‘first element’) providing the first organic cation with a formal positive charge. In some embodiments, X1 is the first element providing the first organic cation with a formal positive charge. In these embodiments, X1 may be considered to be a positive functional group. For instance, X1 may be selected from the group consisting of N, P, As, Sb or Bi. Preferably, X1 is N. In other embodiments the formal positive charge is provided elsewhere than X1; and
a negative functional group including one or more electronegative heteroatoms (the ‘second element’) providing the first organic cation with a partial negative charge. For instance, the heteroatom may be selected from the group consisting of O, N or S.

An advantage of having the reductively vulnerable quaternary N at the X1 position of a spiro compound is that it will be better protected (sterically) from the cathode surface by the A and B rings. This protection will result in increased reductive stability of the cation, which is particularly important at deeply negative potentials such as those present in lithium batteries.

The first organic cation may include more than one negative functional group, or more than one second element within the negative functional group. The second element may be strictly part of ring A and/or B, or may be appendant to ring A and/or B. Preferably, the first organic cation includes a single positive functional group or first element. Also, it is preferable that the first element be X1 in order to protect the first element from facile decomposition.

Rings A and/or B may further include groups selected from lactone, amide, anhydride, carbonate, carbonyl, sulphate, sulphonate, phosphate or phosphonate.

Rings A and/or B may be further substituted, preferably with groups having an electron donating function. For examples, rings A and/or B may be substituted by alkoxide, nitro, amino, amides, esters, and alkenes. Rings A and/or B may also be substituted by alkanes, for example, ring A and/or B may be substituted by alkyl groups (for instance, methyl, ethyl, propyl, and t-Bu alkyl groups). The alkyl groups may have a linear chain length of from about 1 to about 12 atoms. Preferably, the alkyl groups may have a linear chain length of from about 1 to about 8 atoms.

In some embodiments, X1 is two or more atoms that join rings A and B. Preferably, X1 its 2 atoms. In these embodiments, rings A and B may be fused or bridged, and X1 may be C, O, N and B atoms. The carbon atoms may be bonded to each other via alkyl or alkenyl bonds. Typically, in these embodiments X1 is not the first element providing the first organic cation with a formal positive charge, which is provided elsewhere than X1 in rings A and/or. B.

Rings A and B are, in some further embodiments, attached to one or more additional rings of the type A or B as discussed above, as shown in Formula 2:

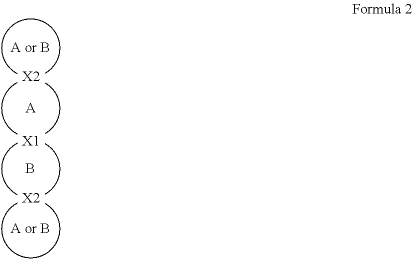

In these embodiments, X2 has the characteristics defined for X1 above.

The first element typically provides a formal positive charge of +1.

The negative functional group typically provides a partial negative charge by either (i) possessing a lone electron pair and the subsequent in resonance/delocalization effect, or (ii) an inductive effect. Examples of (i) include carbonyl functional groups. Examples of (ii) include ether functional groups.

Some suitable compounds are detailed in Table 1 below.

TABLE 1

| Spiro | | | | |
|---|---|---|---|---|
| compounds | Fused | Asymmetric | Asymmetric | |
| (more than | pyrrolidinium | spiro | spiro | |
| 2 rings) | compounds | compounds | compounds | spiromorpholinium |
| 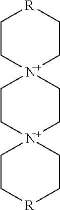 | 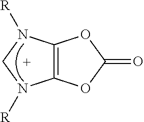 | 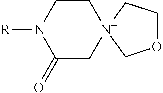 | 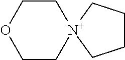 | 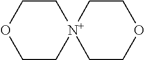 [SMILES: C1C[N+]2(CCO1)CCOCC2] |
| 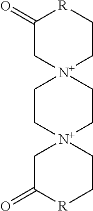 | 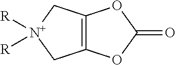 | 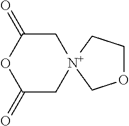 [SMILES: O=C1C[N+]2(CCOC2)CC(=O)O1] | 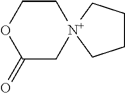 [SMILES: O=C1C[N+]2(CCCC2)CCO1] | 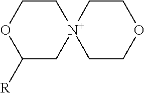 |
| | 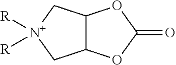 | 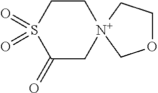 [SMILES: O=C1C[N+]2(CCOC2)CCS1(=O)=O] | 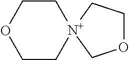 | 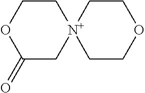 [SMILES: O=C1C[N+]2(CCOCC2)CCO1] |
| | | 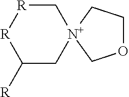 | 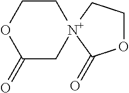 [SMILES: O=C1C[N+]2(CCO1)CCOC2=O] | |

The first organic cation, when present as a sole dopant or as part of an ionic mixture (ionic liquid), is typically not a liquid at room temperature. However, in order to be used in a lithium battery, the electrolyte must be fluid enough to allow the migration of Li ions. Thus, the first organic cation needs to be mixed with other components to cause it to be a room temperature liquid. For instance, the first organic cation may be mixed with any other suitable room temperature liquid (either ionic or aprotic). Or, the skilled person would understand that adding, for instance, carbonyl or methyl groups to a compound would disrupt the order and may lead to a liquid material at room temperature.

The skilled person would understand how to select appropriate first organic cation structures.

Firstly, the skilled person would understand that first organic cations having negative functional groups of varying negativity could be obtained. For instance, a negative functional group including an O atom as the second element, for instance in a morpholinium ring, will be less negative than the same negative functional group including an F atom as the second element. In the case of a negative functional group including an S atom as the second element, for instance in a thiazolium ring, the S, like O, will have two lone electron pairs, which will contribute to a strong δ⁻ charge and the ability to more strongly complex with Li ion. However S is also larger than O and will therefore have a more diffuse partial negative charge resulting in a weaker Li interaction. Or, a negative functional group that is a carbonyl group will be more negative than a functional group that is an ether group.

Secondly, the skilled person would understand that the appropriate negativity of the negative functional groups of the first organic cation is dependent on the application. For instance, a battery involving a Li ion (valence +1) would need to be coordinated by a weaker negative functional group on the first organic cation than would say a battery involving a Mg ion (valence +2), Na ion (valence +2), or Al ion (valence +3). Further, depending on the application, the electrolyte needs to be of a certain ‘robustness’ so that generation of the SEI is optimal (ie not too little and not too much). Further, compounds having two or more negative functional groups may potentially co-ordinate two or more Li ions per first organic cation, or with a single Li ion more strongly, depending on the positioning of the negative functional groups in the first organic cation.

The first organic cation, when used as part of an ionic liquid, could be used together with any ionic liquid anion known to those skilled in the art. Suitable examples of anions are as follows:

(i) bis(trifluoromethylsulfonyl)imide (the term “amide” instead of “imide” is sometimes used in the scientific literature and is used interchangeably in the literature and herein to essentially refer to the same anion with the same characteristics) and is abbreviated to TFSA, TFSI or N(Tf)₂ or another of the sulfonyl imides, including the bis imides and perfluorinated versions thereof. This class includes (CH₃SO₂)₂N⁻, (CF₃SO₂)₂N⁻ (also abbreviated to Tf₂N), (FSO₂)₂N⁻ and (C₂F₅SO₂)₂N⁻ as examples. The bis imides within this group may be of the formula (CₓY₂ₓ₊₁SO₂)₂N⁻ where x=0 to 6 and Y═F or H;
(ii) BF₄⁻ and perfluorinated alkyl fluorides of boron. Encompassed within the class are anions of the formula B(CₓF₂ₓ₊₁)ₐF₄₋ₐ⁻ where x is an integer between 0 and 6, and a is an integer between 0 and 4;

(iii) Halides, alkyl halides or perhalogenated alkyl halides of group VA(15) elements. Encompassed within this class are anions of the formula E(CₓY₂ₓ₊₁)ₐ(Hal)₆₋ₐ⁻ where a is an integer between 0 and 6, x is an integer between 0 and 6, Y is F or H, and E is P; As, Sb or Bi. Preferably E is P or Sb. Accordingly this class encompasses PF₆⁻, SbF₆⁻, P(C₂F₅)₃F₃⁻, Sb(C₂F₅)₃F₃⁻, P(C₂F₅)₄F₂⁻, AsF₆⁻, P(C₂H₅)₃F₃⁻ and so forth;

(iv) CₓY₂ₓ₊₁SO₃⁻ where x=1 to 6 and Y═F or H. This class encompasses CH₃SO₃⁻, nd CF₃SO₃⁻ as examples;

(v) CₓF₂ₓ₊₁COO⁻ where x=1 to 6, including CF₃COO⁻;

(vi) sulfonyl and sulfonate compounds, namely anions containing the sulfonyl group SO₂, or sulfonate group SO₃⁻ not covered by groups (i) and (iv) above. This class encompasses aromatic sulfonates containing optionally substituted aromatic (aryl) groups, such as toluene sulfonate and xylene sulfonate;
(vii) cyanamide compounds and cyano group containing anions, including cyanide, dicyanamide and tricyanomethide;
(viii) Succinamide and perfluorinated succinamide;
(ix) Ethylendisutfonylamide and its perfluorinated analogue;
(x) SCN⁻;
(xi) Carboxylic acid derivatives, including CₓH₂ₓ₊₁COO⁻ where x is an integer between 1 and 6;

(xii) Weak base anions, being the weakly basic anions, such as Lewis base anions, including lactate, formate, acetate, carboxylate, dicyanamide, hexafluorophosphate, bis(trifluoromethanessulfonyl)amide, tetrafluoroborate, methane sulfonate, thiocyanate, tricyanomethide and tesylate;

(xiii) Bis(oxalatoborate) and derivatives thereof; and
(xiv) Halide ions such as the iodide ion.

Amongst these anions, the preferred classes are those outlined in groups (i), (ii), (iii), (iv) and (vi) above, and particularly group (i).

In the above list, and in the specification in general, the term “alkyl” is used in its broadest sense to refer to any straight chain, branched or cyclic alkyl groups of from 1 to 20 carbon atoms in length and preferably from 1 to 10 atoms in length. The term encompasses methyl, ethyl, propyl, butyl, s-butyl, pentyl, hexyl and so forth. The alkyl group is preferably straight chained. The alkyl chain may also contain hetero-atoms, a halogen, a nitrile group, and generally other groups or ring fragments consistent with the substituent promoting or supporting electrochemical stability and conductivity.

Halogen, halo, the abbreviation “Hal” and the like terms refer to fluoro, chloro, bromo and iodo, or the halide anions as the case may be.

### EXAMPLES

### Example 1

### Preparation of SMK TFSA

A mixture of methyl bromoacetate (46.6 g, 0.304 mol), 4-(2-hydroxyethyl)morpholine (39.5 g, 0.301 mol) and toluene (300 mL) was heated to 90° C. Methanol was allowed to distil from the reaction mixture for 8 h at which point the temperature was raised to 130° C. until toluene began to distil from the reaction mixture. The white, solid product was filtered, washed with hexanes and crystallized from boiling water at −10° C. Yield 42.6 g (56.1%).

The 2-oxo-3,9-dioxa-6-azoniaspiro[5.5]undecane bis(trifluoromethylsulfonyl)amide defined herein as [SMK][TFSA] was prepared from 2-oxo-3,9-dioxa-6-azoniaspiro[5.5]undecane bromide [SMK][Br] (5.91 g, 23.5 mmol) and Li[TFSA] (6.74 g, 23.5 mmol) were each dissolved in 150 mL water. After combining the two solutions the biphasic reaction mixture was heated until a homogeneous solution was formed. After cooling to 5° C. for 24 h the colourless, crystalline product was filtered and washed with 5° C. water. Yield 2.92 g (27.5%).

### Example 2

### Electrochemical Characterisation of SMK TFSA

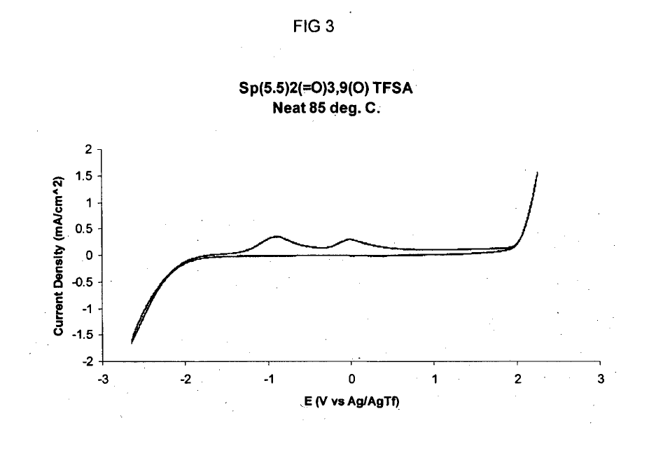

To determine the electrochemical window of the neat SMK TFSA compound, a small vial of material ˜2 g was melted and held at 85° C. in an oil bath within a dry Argon glove box. Two platinum wires have been used as both the counter and working electrodes, respectively, and Ag|Ag⁺ reference electrode as described by G. A. Snook et al. Electrochem Commun., 8 2006, 1405. FIG. 3 shows the electrochemical window of this compound. The experiment was conducted using a scan rate of 50 mV.s⁻¹ and scanning reductively first.

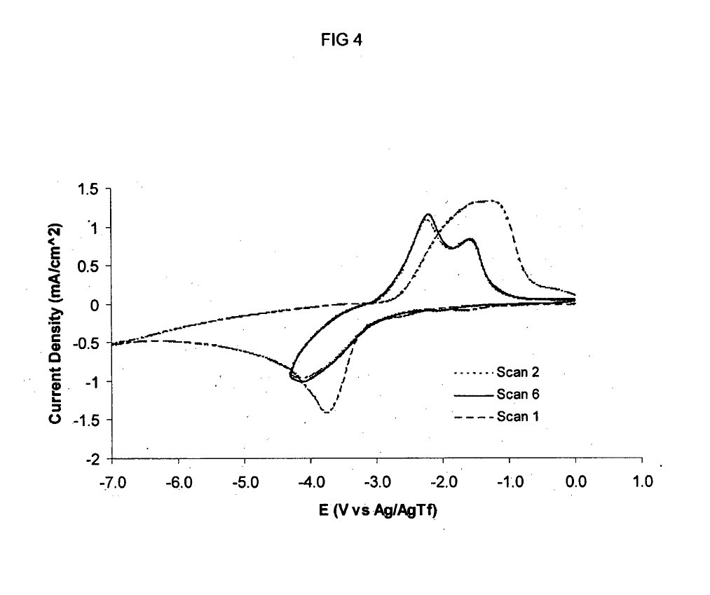

FIG. 4 shows that on the addition of lithium salt to the Spiro compound, we find the reductive limit of the electrolyte at 85° C. exceeds −7 V vs. Ag|Ag⁺ reference electrode which would make these electrolytes the most stable reported to-date. Other state of the art electrolytes based on pyrrolidinium TFSA for lithium metal batteries show similar behaviour, but generally this window is enhanced by 1 V negative of the lithium plating potential. We note after the first scan, that subsequent scans show relatively little change in the peak current density of the oxidation and reduction peak of Lithium, suggesting a stable SEI interface has been formed on the Pt working electrode.

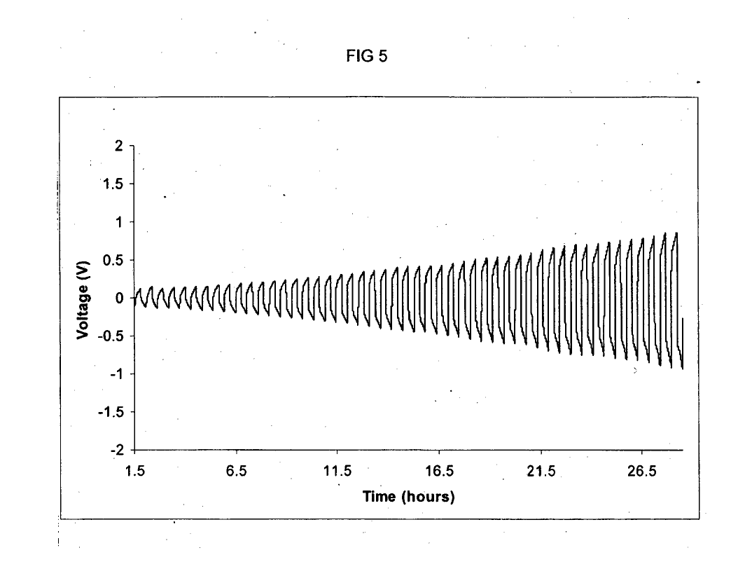

FIG. 5 shows a lithium:lithium symmetrical coin cell (CR2032) cycling results using Separion as the separator with the SMK TFSA 0.4 mol.kg⁻¹ LiTFSA as the electrolyte. The cell was cycled at 0.1 mA.cm⁻² and 85° C. as the electrolyte is a liquid at this temperature. We note the increasing polarisation of this cell with increasing cycle number which is caused by the high viscosity of the solution at this temperature slowing the lithium ion motion.

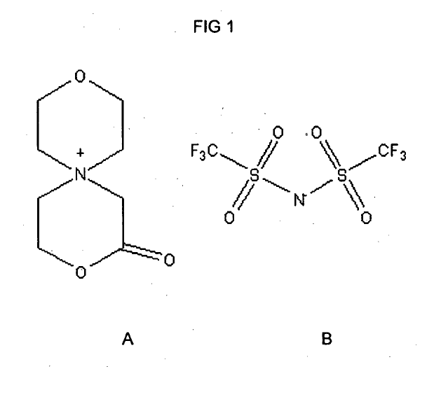

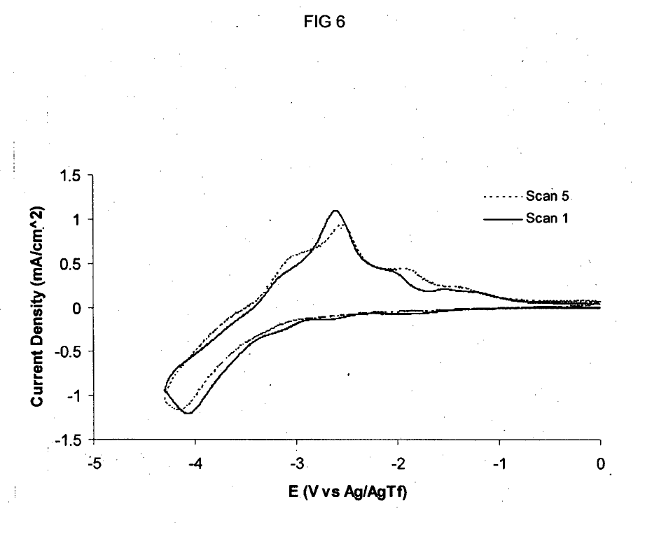

We have also made mixtures of the SMK TFSA compound in FIG. 1 with the well known 1-methyl-propylpyrrolidinium bis(trifluoromethansulfonyl)imide or C₃mpyr TFSA compound containing a lithium salt of the same anion. The aim of the experiment is to use the oxygen groups on the spiro-based cation to weakly interact with the lithium-ion in solution, to dissociate any negatively charged anion clusters in solution. Also, as we demonstrated in FIG. 4, the spiro compounds appear to form favourable SEI's in their own right, hence we hope to further stabilise Lithium plating and stripping. FIG. 6 demonstrates a mixture of the two ionic liquids and lithium salt showing that between scans 1 and 5 there is very little degradation of the lithium plating and stripping currents between these scans.

### Example 3

### Battery using SMK TFSA as an Additive

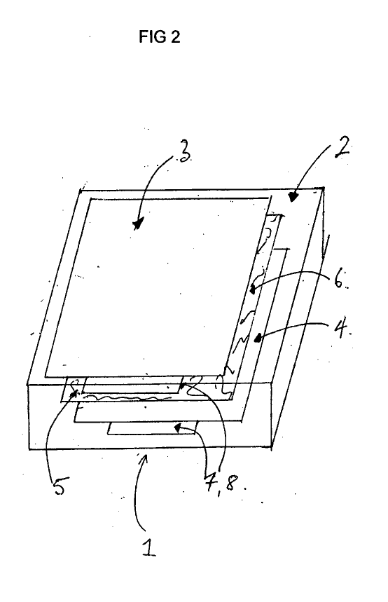

A secondary lithium battery (1) produced in accordance with the invention is shown schematically in FIG. 2. This battery comprises a case (2), at least one positive electrode (3) (one is shown) comprising lithium iron phosphate, at least one negative electrode (4) (one is shown) an ionic liquid electrolyte comprising an anion and a cation counterion and a lithium salt (5), a separator (6) and electrical terminals (7,8) extending from the case (2). The battery (1) illustrated is shown in plate-form, but it may be in any other form known in the art, such as spiral wound form.

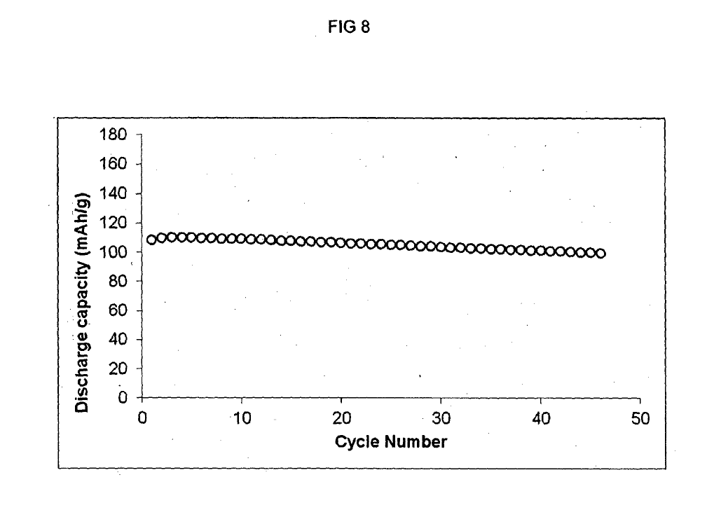

We have made batteries with mixtures of the SMK TFSA compound in FIG. 1 with C₃mpyr TFSA compound containing LiTFSA. The electrolyte is prepared by adding 0.25 mol/kg of SMK TFSA to C₃mpyrTFSA and stirring until the solid is dissolved. To this 0.5 mol/kg of LiTFSA is added with further stirring until solid is dissolved. All additions are performed in a high purity argon glovebox and the final electrolyte mixture contains 35 ppm of water. All batteries whose data is shown in FIGS. 8 to 11 have been constructed by the following method. The anode consists of a lithium metal foil which has been cleaned by washing in hexane and scrubbed to remove surface impurities. The cathode consists of a LiFePO₄ active material with Shawinigan black carbon additive and PVdF binder at ratios of 75:15:10. The cathode loading is 1.5 mg.cm⁻². The anode is cut to a 13 mm diameter disc while the cathode is cut to a 13 mm diameter disc. The separator is cut to a 15 mm disc. All the electrodes and separator are stacked into a CR2032 coin cell containing a Teflon gasket and 70 μL of electrolyte solution is added. The CR2032 coin cell is then sealed using a commercially available coin cell press.

The prepared batteries are then stored at the operating temperature used for the cycling measurements for 12 hours prior to cycling. All cycling has been performed at a charge rate of C/10 and a discharge rate of C/10.

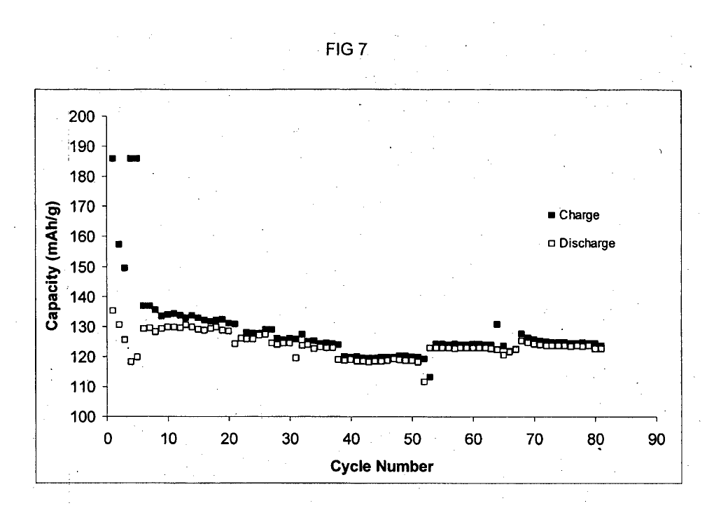

The optimal electrolyte mixture was determined from successive experiments by varying the concentration of SMK TFSA in the host ionic liquid C₃mpyr TFSA in steps of 0.1, 0.25, 0.5 and 1 mol.kg⁻¹ while maintaining the lithium salt concentration at 0.5 mol.kg⁻¹ in the final electrolyte. FIG. 7 shows that at a concentration of 0.25 mol.kg⁻¹, the SMK TFSA stabilises the battery capacity at ˜130 mAh.g⁻¹ at 50° C.

### Example 4

### Battery Cycling at 80° C.

A battery was prepared whereby SMK TFSA is used as an additive to the C₃mpyr TFSA ionic liquid electrolyte as described earlier. FIG. 8 shows the battery cycling at a rate of C/10 charge and C/10 discharge and plotted is the discharge capacity and shows that the SMK TFSA can stabilise cycling at 80° C. using a commercially available Separion separator. The figures shows that a stable capacity of ˜105 mAh/g is achieved using SMK TFSA as an additive

### Example 5

### Battery Cycling at 115° C.

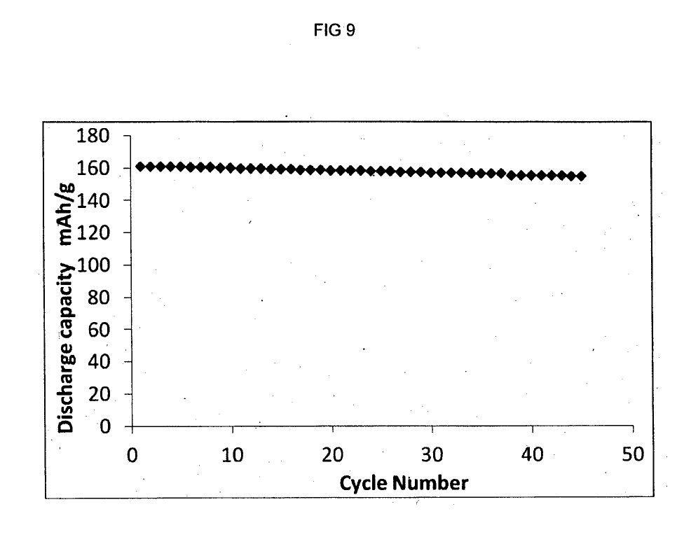

A battery was prepared whereby SMK TFSA is used as an additive to the C₃mpyr TFSA ionic liquid electrolyte as described earlier. FIG. 9 shows the battery cycling at a rate of C/10 charge and C/10 discharge and plotted is the discharge capacity and shows that the SMK TFSA can stabilise cycling at 115° C. using a commercially available Separion separator. The figure shows that at the higher temperature the battery operates better and the decay in discharge capacity is not as significant as at lower temperature. The figure also shows a stable capacity of ˜160 mAh/g is achieved using SMK TFSA as an additive which'is a higher value then for 80° C.

### Example 6

### Battery cycling at 80° C. with Different Separators

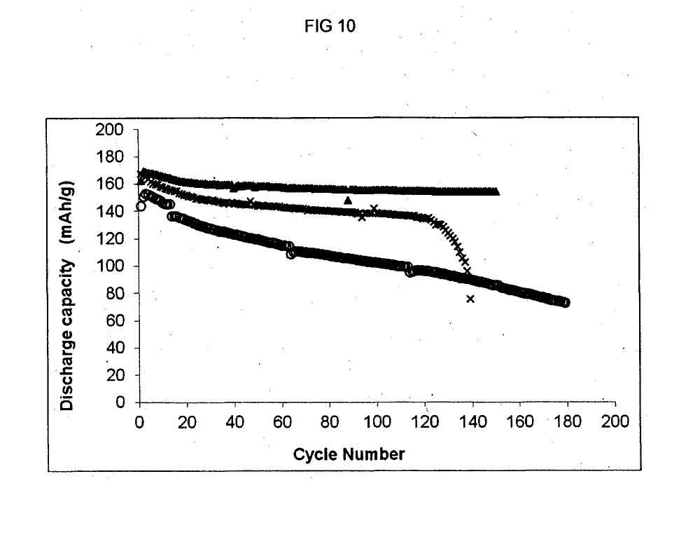

Three batteries were prepared whereby SMK TFSA is used as an additive to the C₃mpyr TFSA ionic liquid electrolyte as described earlier. The first battery contains the Separion separator, the second battery contains a modified PVdF separator and the third battery contains a PAN (polyacrylonitrile). FIG. 10 shows the battery cycling at a rate of C/10 charge and C/10 discharge and plotted is the discharge capacity (data for the battery with Separion separator is open circles, for the battery with PVdF separator is filled triangles and for the battery with PAN separator is crosses). FIG. 9 shows that the battery containing the modified PVdF separator and SMK TFSA additive stabilises battery cycling compared to batteries containing Separion and SMK TFSA additive or PAN separator and SMK TFSA additive at 80° C.

### Example 7

### Battery Cycling at 120° C.

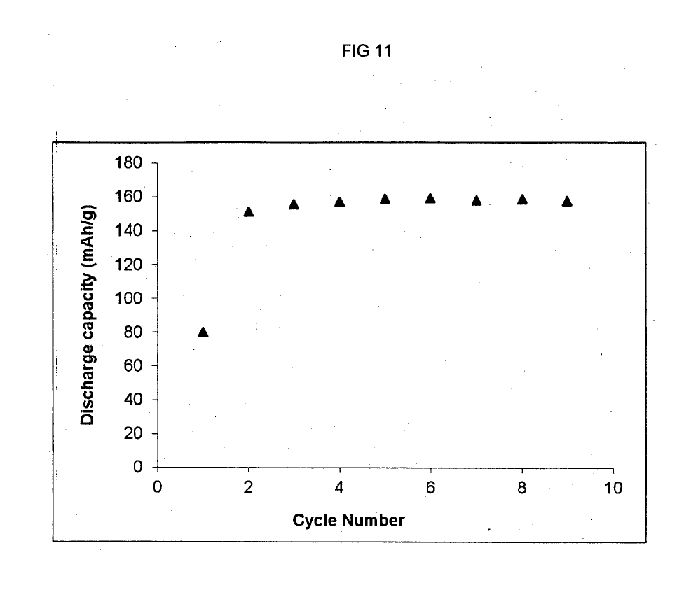

A battery was prepared whereby SMK TFSA is used as an additive to the C₃mpyr TFSA ipnic liquid electrolyte as described earlier. FIG. 11 shows the battery cycling at a rate of C/10 charge and C/10 discharge and plotted is the discharge capacity and shows that the SMK TFSA can stabilise cycling at 120° C. when using a modified PVdF separator. The figure also shows a stable capacity of ˜160 mAh/g is achieved using SMK TFSA as an additive and the PVdF seperator

It is expected that an appropriate selection of electrolytes including the organic cation of the invention and particularly SMK, anion and metal salt can show stable cycling at operating temperatures up to 200° C. These batteries will have application in high temperature environments and may be particularly suited to use in sensors and monitoring equipment such as those found in the oil and gas industry.

It will be understood that the invention disclosed and defined in this specification extends to all alternative combinations of two or more of the individual features mentioned or evident from the text or drawings. All of these different combinations constitute various alternative aspects of the invention.

1.-47. (canceled)

48. An organic cation for a battery, including a heteroatom-containing cyclic compound having at least 2 ring structures formed from rings that share at least one common atom, the cyclic compound having both a formal positive charge of at least +1 and a partial negative charge.

49. The organic cation of claim 48, wherein the cyclic compound is selected from the group consisting of:
(a) spirocyclic compounds selected from the group consisting of: 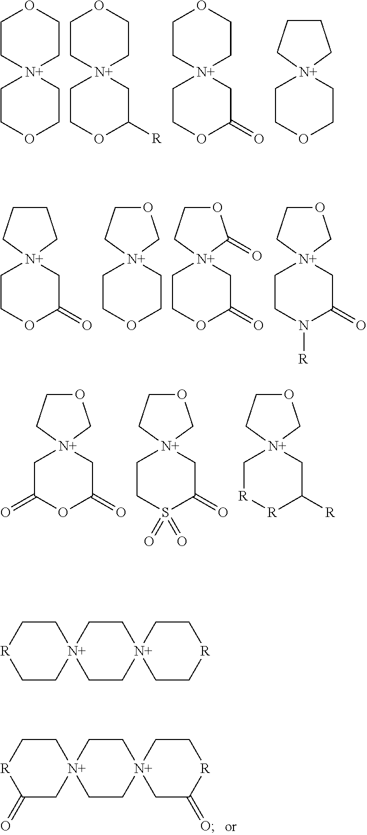
(b) fused compounds selected from the group consisting of:

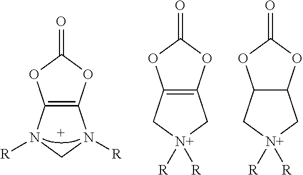

50. The organic cation of claim 49 used as electrolyte in a battery or as an additive to an ionic liquid or carbonate based solvent electrolytes in the concentration of 0.1 to 1.5 mol/kg.

51. The organic cation of claim 50 used as an additive to an ionic liquid or carbonate based solvent electrolytes in the concentration of 0.25 mol/kg.

52. An ionic liquid including:
an organic cation according to claim 49; and
an anion.

53. The ionic liquid of claim 52 wherein the anion is selected from the group consisting of tetrafluoroborate (BF₄), bis(fluorosulfonyl)imide (FSA) and bis(trifluoromethanesulfonyl)imide (TFSA) or derivatives thereof.

54. An electrolyte including:
a first organic cation according to claim 49; and
a first anion.

55. The electrolyte of claim 54 further including at least one of:
a second ionic liquid having a second organic cation and a second anion; or
a carbonate based solvent.

56. The electrolyte of claim 55 wherein the amount of the first organic cation as a percentage of the total organic cation is from about 1% to about 99%.

57. The electrolyte of claim 56 wherein the first organic cation is an additive to the electrolyte.

58. The electrolyte of claim 57 wherein the first organic cation is present in the concentration of 0.1 to 1.5 mol/kg.

59. The electrolyte of claim 58 wherein the first organic cation is present in the concentration of 0.25 mol/kg.

60. The electrolyte of claim 55 wherein the structure of the second organic cation is selected from the group of imidazolium (eg 1-ethyl-3-methylimidazolium (EMI)), pyrrolidinium or morpholinium or derivatives thereof

61. The electrolyte of claim 55 wherein the first and second anions are selected from the group consisting of tetrafluoroborate (BF₄), bis(fluorosulfonyl)imide (FSA) or bis(trifluoromethanesulfonyl)imide (TFSA) or derivatives thereof

62. The electrolyte of claim 54 further including a metal salt.

63. The electrolyte of claim 62 for application in a lithium battery wherein the metal salt is a lithium salt including a Li cation.

64. The electrolyte of claim 63 wherein the concentration of lithium ions in the electrolyte is in the range of 0.1 to 1.5 mol/kg.

65. The electrolyte of claim 64 wherein with the wherein the concentration of lithium ions in the electrolyte is about 0.5 mol/kg.

66. A battery including:
at least one anode and at least one cathode; and
an electrolyte according to claim 54, for fluid communication between the anode and cathode.

67. The battery of claim 66 further including a separator.
